(19) United States
(12) Patent Application Publication
(10) Pub. No.: US 2003/0180546 A1
(43) Pub. Date: Sep. 25, 2003

(54) Heat treatable coated article with chromium nitride IR reflecting layer and method of making same

(75) Inventors: Grzegorz Stachowiak, Ann Arbor, MI (US); George Neuman, Ann Arbor, MI (US); Hong Wang, Belleville, MI (US)

Correspondence Address: NIXON & VANDERHYE, PC, 1100 N GLEBE ROAD, 8TH FLOOR, ARLINGTON, VA, 22201-4714, US

(73) Assignee: Guardian Industries Corp.

(21) Appl. No.: 10/353,088

(22) Filed: Jan. 29, 2003

Related U.S. Application Data
(63) Continuation-in-part of application No. 09/847,663, filed on May 3, 2001, now Pat. No. 6,524,714.

(51) Int. Cl. B32B 17/06

(52) U.S. Cl. 428/432; 428/426; 428/698; 428/689

(57) ABSTRACT

A coated article is provided so as to include a solar control coating having an infrared (IR) blocking (reflecting and/or absorbing) layer sandwiched between at least a pair of dielectric layers. The IR reflecting layer includes chromium nitride (CrₓN_{y}) in certain example embodiments. The use of chromium nitride enables the coated article to have good corrosion resistance to acid(s), good mechanical performance such as scratch resistance, and/or good color stability (i.e., a low ΔE* value(s)) upon heat treatment (HT). The coated article may be heat treated (e.g., thermally tempered) in certain example embodiments of the invention.

This application is a continuation-in-part (CIP) of U.S. patent application Ser. No. 09/847,663, filed May 3, 2001, the disclosure of which is hereby incorporated herein by reference.

### HEAT TREATABLE COATED ARTICLE WITH CHROMIUM NITRIDE IR REFLECTING LAYER AND METHOD OF MAKING SAME

This invention relates to coated articles that include at least one chromium nitride infrared (IR) reflecting layer sandwiched between at least a pair of dielectric layers, and/or a method of making the same. Such coated articles may be used in the context of monolithic windows, insulating glass (IG) window units, laminated windows, and/or other suitable applications.

### BACKGROUND OF THE INVENTION

The need for color matchability of coated articles (before heat treatment vs. after heat treatment) is known. Glass substrates are often produced in large quantities and cut to size in order to fulfill the needs of a particular situation such as a new multi-window and door office building, other window needs, etc. It is often desirable in such applications that some of the windows and/or doors be heat treated (i.e., tempered, heat strengthened or bent), while others need not be. Office buildings often employ IG units and/or laminates for safety and/or thermal control. It is often desirable that the units and/or laminates which are heat treated (HT) substantially match their non-heat treated counterparts (e.g., with regard to color, reflectance, and/or the like) for architectural and/or aesthetic purposes.

U.S. Pat. No. 5,376,455 discloses a coated article including: glass/Si₃N₄/NiCr/Ag/NiCr/Si₃N₄. Unfortunately, the coating system of the '455 patent is not sufficiently color matchable after heat treatment with its non-heat-treated counterpart. In other words, the coating system of the '455 patent has a rather high ΔE value. This means that, unfortunately, two different coated articles with different coatings (one to be heat treated, the other not to be) must be made for customers who want their heat-treated and non-heat-treated coated articles to approximately match colorwise as viewed by the naked eye.

As with the '455 patent, it has mostly been possible to achieve matchability only by providing two different layer systems, one of which is heat treated (HT) and the other is not. The necessity of developing and using two different layer systems to achieve matchability creates additional manufacturing expense and inventory needs which are undesirable.

However, commonly owned U.S. Pat. No. 5,688,585 discloses a solar control coated article including glass/Si₃N₄/NiCr/Si₃N₄, wherein matchability is achieved with a single layer system. As explained at column 9 of the '585 patent, it is a “requirement” of the '585 invention that the NiCr layer be substantially free of any nitride. An object of the '585 patent is to provide a sputter coated layer system that after heat treatment is matchable colorwise with its non-heat-treated counterpart. However, the '585 patent uses a heat treatment (HT) of only three (3) minutes (col. 10, line 55). Longer heat treatments are often desired in order to attain better tempering or HT characteristics. Unfortunately, as explained below, it has been found that with longer HT times the coatings of the '585 patent cannot maintain low ΔE values and thus lose color matchability.

Consider the following layer stack: glass/Si₃N₄/NiCr/Si₃N₄, where the underlayer of Si₃N₄ is about 50-70 Å (angstroms) thick, the NiCr layer is about 325 Å thick (the NiCr layer is not nitrided as deposited as can be seen in FIG. 15), and the overcoat of Si₃N₄ is about 210-310 Å thick. It is noted that some amount of nitriding of the NiCr may possibly occur during heat treatment. Unfortunately, given the deposited NiCr layer, this coated article has a rather high transmissive ΔE* value of about 5.9 after a heat treatment (HT) at 625 degrees C. for ten (10) rinutes. This high transmissive ΔE value means that a HT version of the '585 coated article does not approximately match colorwise non-heat-treated counterpart versions with regard to transmissive color after 10 minutes of HT. Moreover, such stacks have a glass side reflective ΔE* value of above 5.0 after heat treatment (HT) at 625 degrees C. for ten minutes. These high glass side reflective ΔE* values are not desirable, and they prevent appearance matchability between HT and non-HT versions of the same coating.

Unfortunately, the layer stack of glass/Si₃N₄/NiCr/ Si₃N₄, where the Ni/Cr ratio is 80/20, while providing efficient solar control and being overall good coatings, is also sometimes are lacking in terms of: (a) corrosion resistance to acid (e.g., HCl boil); and (b) mechanical performance such as scratch resistance; in addition to the problems described above associated with (c) thermal stability upon heat treatment for tempering, heat bending, or the like (i.e., ΔE* value(s)).

Accordingly, there exists a need in the art for a coated article that has improved characteristics with respect to (a), (b) and/or (c) compared to a conventional layer stack of glass/Si₃N₄/NiCr/Si₃N₄, but which still is capable of acceptable solar control (e.g., blocking a reasonable amount of IR and/or UV radiation) and/or heat treatment. It is a purpose of this invention to fulfill at least one of the above-listed needs, and/or other needs which will become apparent to the skilled artisan once given the following disclosure.

### SUMMARY OF THE INVENTION

In certain example embodiments of this invention, a coating or layer system is provided which includes an infrared (IR) reflecting layer comprising chromium nitride sandwiched between at least a pair of dielectric layers. In certain example embodiments, the coating or layer system has good corrosion resistance to acid(s) such as HCl, good mechanical performance such as scratch resistance, and/or good color stability (i.e., a low ΔE* value(s)) upon heat treatment (HT).

For example, a coating or layer system including an IR reflecting layer comprising chromium nitride has been found to have better durability (e.g., with respect to acid exposure) than the aforesaid conventional coating including a NiCr IR reflecting layer. Moreover, it has surprisingly been found that the use of chromium nitride as an IR reflecting layer enables a solar control coating to have significantly improved stability upon HT (e.g., a lower ΔE* value with a given HT time) than the aforesaid conventional coating where metallic NiCr is used as the IR reflecting layer.

A coated article according to an example embodiment of this invention utilizes such a chromium nitride layer sandwiched between a pair of silicon nitride dielectric layers.

Coated articles according to certain embodiments of this invention may be used as monolithic windows due to their excellent durability characteristics, which may or may not be heat treated. Alternatively, coated articles according to this invention may also be used in the context of insulating glass (IG) window units, or in other suitable application, which may or may not involve heat treatment.

In certain example embodiments of this invention, heat treated (HT) coated articles including a chromium nitride IR reflecting layer have a ΔE* value (glass side reflective and/or transmissive) of no greater than 5.0, still more preferably no greater than 4.0, more preferably no greater than 3.0, even more preferably no greater than 2.5, still even more preferably no greater than 2.0, and most preferably no greater than 1.8. For purposes of example, the heat treatment (HT) may be for at least about 5 minutes at a temperature(s) of at least about 580 degrees C., and may be at a temperature of at least about 600 degrees C. for a period of time of at least 5 minutes (more preferably at least 7 minutes, and most preferably at least 9 minutes) in certain example embodiments.

In certain example embodiments of this invention, the IR reflecting layer which is sandwiched between at least a pair of dielectric layers may comprise, consist essentially of, or consist of chromium nitride. In certain example embodiments, the chromium nitride IR reflecting layer may be represented by CrₓN_{y}, where the y/x ratio is from 0.25 to 0.7, even more preferably from 0.3 to 0.6, still more preferably from 0.45 to 0.55. For purposes of example only, Cr₂N translates into a y/x ratio of 1/2 (i.e., 0.5). It has surprisingly been found that these particular y/x ratio range(s) for nitrides of chromium(Cr) are particularly beneficial with respect to thermal, optical and/or durability characteristics. For instance, nitriding of Cr in amounts greater than this may result in less durability (e.g., mechanical and/or chemical resistance).

Generally speaking, certain example embodiments of this invention fulfill one or more of the above listed needs by providing a heat treated coated article comprising: a layer system supported by a glass substrate, said layer system comprising a layer comprising chromium nitride located between first and second dielectric layers, wherein the second dielectric layer is at least partially nitrided and positioned so that the layer comprising chromium nitride is between the second dielectric layer and the glass substrate; and wherein said coated article has a ΔE* value (glass side reflective and/or transmissive) no greater than 4.0 after heat treatment at a temperature(s) of at least about 600 degrees C.

In certain other example embodiments of this invention, one or more of the above-listed needs is/are fulfilled by providing a method of making a coated article, the method comprising: sputtering a first dielectric layer on a substrate; sputtering a layer comprising chromium nitride on the substrate over the first dielectric layer; sputtering a second dielectric layer on the substrate over the layer comprising chromium nitride; and wherein the layer comprising chromium nitride is sputtered so as to form CᵣN_{y} where y/x is from 0.3 to 0.7.

### IN THE DRAWINGS

FIG. 1 is a partial cross sectional view of an embodiment of a monolithic coated article (heat treated or not heat treated) according to an example embodiment of this invention.

FIG. 2 is a partial cross-sectional view of an IG window unit as contemplated by this invention, in which the coating or layer system of FIG. 1 may be used.

FIG. 3 is a graph plotting nitrogen gas flow as a % of total gas flow during sputtering of a chromium nitride layer vs. Cr, N atomic content in the resulting layer, illustrating stoichiometry of chromium nitride layers according to different embodiments of this invention as a function of nitrogen gas flow during sputtering (N and Cr atomic percentages were determined using XPS).

FIG. 4 is a graph plotting nitrogen gas flow as a percentage of total gas flow during sputtering of a chromium nitride layer vs. the resulting ratio y/x (given CrₓN_{y}) in the resulting chromium nitride layer according to different embodiments of this invention, thereby illustrating different stoichiometries of the layer as a function of the amount of nitrogen in the total sputtering gas flow (N and Cr atomic percentages were determined using XPS).

FIG. 5 is a graph plotting nitrogen gas flow (in units of sccm) during sputtering of a chromium nitride layer vs. the resulting ratio y/x (given CrₓN_{y}) in the resulting chromium nitride layer according to different embodiments of this invention, thereby illustrating different stoichiometries of the layer as a function of nitrogen gas flow during sputtering (N and Cr atomic percentages were determined using XPS).

### DETAILED DESCRIPTION OF CERTAIN EXAMPLE EMBODIMENTS OF THE INVENTION

Certain embodiments of this invention provide a coating or layer system that may be used in windows such as monolithic windows (e.g., vehicle, residential, or architectural windows), IG window units, and/or other suitable applications. Certain example embodiments of this invention provide a layer system that is characterized by good (a) corrosion resistance to acid (e.g., which can be tested via an HCl boil); (b) mechanical performance such as scratch resistance; and/or (c) thermal stability upon heat treatment. With respect to thermal stability upon heat treatment (HT), this means a low value of ΔE* (glass side reflective and/or transmissive); where Δ is indicative of change in view of HT such as thermal tempering, heat bending, or thermal heat strengthening, monolithically and/or in the context of dual pane environments such as IG units or laminates. Such heat treatments sometimes necessitate heating the coated substrate to temperatures from about 580° C. up to about 800° C. for 4-5 minutes or more, and in certain embodiments at a temperature(s) of at least about an oven setting of 600 degrees C. for a period of time of at least 4 or 5 minutes (more preferably at least 7 minutes, and most preferably at least 9 minutes) in certain example embodiments.

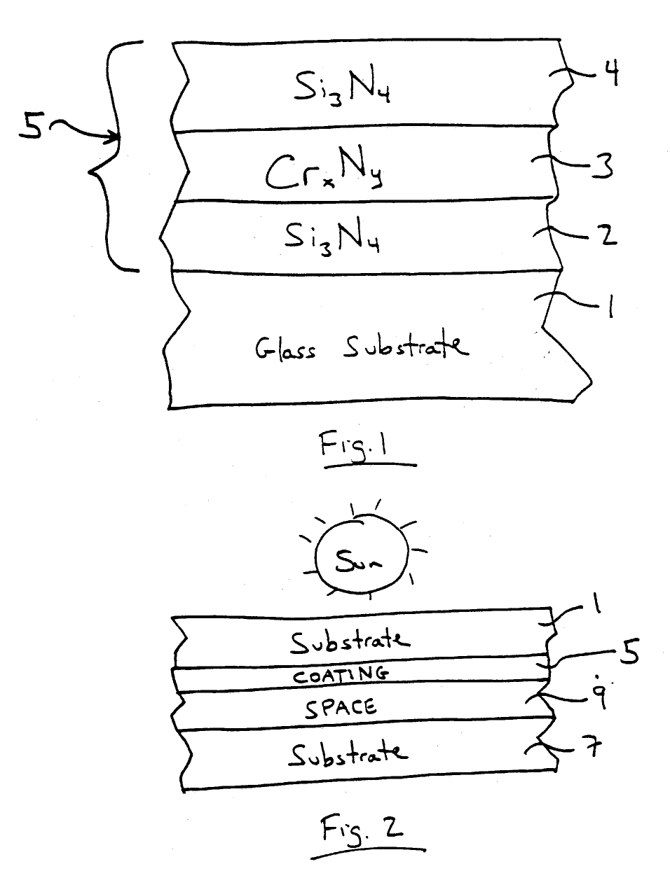

FIG. 1 is a side cross sectional view of a coated article according to an example embodiment of this invention. The coated article includes at least substrate 1 (e.g., clear, green, bronze, grey, blue, or blue-green glass substrate from about 1.0 to 12.0 mm thick), first optional dielectric layer 2 (e.g., of or including silicon nitride (e.g., Si₃N₄), tin oxide, or some other suitable dielectric), infrared (IR) reflecting layer 3 comprising, consisting essentially of, or consisting of chromium nitride (CrₓN_{y}), and second dielectric layer 4 (e.g., of or including silicon nitride (e.g., Si₃N₄), tin oxide, or some other suitable dielectric. In certain example embodiments of this invention, coating 5 does not include any metallic IR reflecting layer such as Ag or Au. In such embodiments, chromium nitride IR reflecting layer 3 may be the only IR reflecting layer in coating 5. In certain example embodiments of this invention, chromium nitride IR reflecting layer 3 does not contact any metal IR reflecting layer.

In certain example embodiments of this invention, IR reflecting layer 3 is substantially free of Ni (i.e., contains no more than about 10% Ni, more preferably no more than 5% Ni, even more preferably no more than 1% Ni, and most preferably no more than 0.01% Ni).

Overall coating 5 includes at least layers 2-4. It is noted that the terms “oxide” and “nitride” as used herein include various stoichiometries. For example, the term silicon nitride includes stoichiometric Si₃N₄, as well as non-stoichiometric silicon nitride such as Si-rich silicon nitride. Layers 2-4 may be deposited on substrate 1 via magnetron sputtering, or via any other suitable technique in different embodiments of this invention.

In certain example embodiments of this invention, IR reflecting layer 3 is sputter-deposited as chromium nitride. The stoichiometry of this layer as deposited may be represented, in certain example embodiments, by CrₓN_{y}, where the ratio y/x (i.e., the ratio of N to Cr) is from 0.25 to 0.7, even more preferably from 0.3 to 0.6, still more preferably from 0.45 to 0.55. For purposes of example only, chromium nitride in the form of Cr₂N translates into a y/x ratio of 1/2 (i.e., 0.5). It has surprisingly been found that the aforesaid y/x ratio ranges for nitrides of chromium are particularly beneficial with respect to coating characteristics such as durability and optical performance. For instances, nitriding of Cr in amounts greater than this (approaching CrN where y/x=1) may result in less chemical resistance of coating 5 and/or poor adhesion to silicon nitride especially after HT. In other words, if the y/x ratio is greater than the aforesaid range(s), durability degrades in certain instances.

While FIG. 1 illustrates coating 5 in a manner where CrₓN_{y} layer 3 is in direct contact with dielectric layers 2 and 4, and wherein CrₓN_{y} layer 3 is the only IR reflecting layer in the coating, the instant invention is not so limited. Other layer(s) may be provided between layers 2 and 3 (and/or between layers 3 and 4) in certain other embodiments of this invention. Moreover, other layer(s) may be provided between substrate 1 and layer 2 in certain embodiments of this invention; and/or other layer(s) may be provided on substrate 1 over layer 4 in certain embodiments of this invention. Thus, while the coating 5 or layers thereof is/are “on” or “supported by” substrate 1 (directly or indirectly), other layer(s) may be provided therebetween. Thus, for example, the layer system 5 and layers thereof shown in FIG. 1 are considered “on” the substrate 1 even when other layer(s) may be provided therebetween (i.e., the terms “on” and “supported by” as used herein are not limited to directly contacting).

Surprisingly, it has been found that the use of CrₓN_{y} in layer 3 (as opposed to NiCr) results in a coated article having: (a) improved corrosion resistance with respect to acid such as HCl; (b) improved mechanical durability; and (c) improved color stability upon heat treatment (i.e., lower ΔE* value(s)).

In certain example embodiments of this invention, dielectric anti-reflection layers 2 and/or 4 each may have an index of refraction “n” of from about 1.5 to 2.5, more preferably from 1.9 to 2.3. In embodiments of this invention where layers 2 and/or 4 comprise silicon nitride (e.g., Si₃N₄), sputtering targets including Si employed to form these layers may or may not be admixed with up to 6-20% by weight aluminum and/or stainless steel (e.g. SS#316), with about this amount then appearing in the layers so formed.

While FIG. 1 illustrates a coated article according to an embodiment of this invention in monolithic form, FIG. 2 illustrates the coating or layer system 5 of FIG. 1 being utilized on surface #2 of an IG (insulating glass) window unit. In FIG. 2, the two glass substrates (e.g., float glass 2 mm to 12 mm thick) 1, 7 are sealed at their peripheral edges by a conventional sealant and/or spacer (not shown) and may be provided with a conventional desiccant strip (not shown). The panes are then retained in a conventional window or door retaining frame. By sealing the peripheral edges of the glass sheets and replacing the air in insulating space (or chamber) 9 with a gas such as argon, a high insulating value IG unit is formed as illustrated in FIG. 2. Optionally, insulating space 9 may be at a pressure less than atmospheric pressure in certain alternative embodiments, although this of course is not necessary in all IG embodiments. In IG embodiments, coating 5 from FIG. 1 may be provided on the inner wall of substrate 1 in certain embodiments of this invention (as in FIG. 2), and/or on the inner wall of substrate 7 in other embodiments of this invention.

Turning back to FIG. 1, while various thicknesses may be used consistent with one or more of the objects and/or needs discussed herein. According to certain non-limiting example embodiments of this invention, example thicknesses and materials for the respective layers on the glass substrate 1 are as follows:

TABLE 1
(Example non-limiting thicknesses)

| Layer | Example Range (Å) | Preferred (Å) | Best (Å) |
|---|---|---|---|
| silicon nitride | 10-1,200 Å | 20-1,000 Å | 50-900 Å |
| (layer 2): | | | |
| CrₓN_{y} | 50-700 Å | 100-500 Å | 100-300 Å |
| (layer 3): | | | |
| silicon nitride | 50-900 Å | 100-500 Å | 200-400 Å |
| (layer 4): | | | |

In certain exemplary embodiments, the color stability with HT may result in substantial matchability between heat-treated and non-heat treated versions of the coating or layer system. In other words, in monolithic and/or IG applications, in certain embodiments of this invention two glass substrates having the same coating system thereon (one HT after deposition and the other not HT) appear to the naked human eye to look substantially the same. Stated yet another way, the coated article has good color stability upon HT.

The value(s) ΔE* is important in determining whether or not there is matchability, or substantial color matchability upon HT, in the context of certain embodiments of this invention (i.e., the term ΔE* is important in determining color stability upon HT). Color herein is described by reference to the conventional a*, b* values. For example, the term Δa* is indicative of how much color value a* changes due to HT.

The term ΔE* (and ΔE) is well understood in the art and is reported, along with various techniques for determining it, in ASTM 2244-93 as well as being reported in Hunter et. al., The Measurement of Appearance, 2^{nd} Ed. Cptr. 9, page 162 et seq. (John Wiley & Sons, 1987). As used in the art, ΔE* (and ΔE) is a way of adequately expressing the change (or lack thereof) in reflectance and/or transmittance (and thus color appearance, as well) in an article after or due to HT. ΔE may be calculated by the “ab” technique, or by the Hunter technique (designated by employing a subscript “H”). ΔE corresponds to the Hunter Lab L, a, b scale (or Lₕ, a_{h,} bₕ). Similarly, ΔE* corresponds to the CIE LAB Scale L*, a*, b*. Both are deemed useful, and equivalent for the purposes of this invention. For example, as reported in Hunter et. al. referenced above, the rectangular coordinate/scale technique (CIE LAB 1976) known as the L*, a*, b* scale may be used, wherein:

L* is (CIE 1976) lightness units

a* is (CIE 1976) red-green units

b* is (CIE 1976) yellow-blue units

and the distance ΔE* between L*_{O} a*_{O} b*_{O} and L*₁ a*₁ b*₁ is:

ΔE*={(ΔL*)²+(Δa*)²+(Δb*)²}^{1/2} (1)

where:

ΔL*=L*₁−L*_{O} (2)

Δa*=a*₁−a*₀ (3)

Δb*=b*₁−b*₀ (4)

where the subscript “0” represents the coating (or coated article) before heat treatment and the subscript “1” represents the coating (or coated article) after heat treatment; and the numbers employed (e.g., a*, b*, L*) are those calculated by the aforesaid (CIE LAB 1976) L*, a*, b* coordinate technique. In a similar manner, ΔE may be calculated using equation (1) by replacing a*, b*, L* with Hunter Lab values aₕ, bₕ, Lₕ. Also within the scope of this invention and the quantification of ΔE* are the equivalent numbers if converted to those calculated by any other technique employing the same concept of ΔE* as defined above.

After heat treatment (HT) such as thermal tempering, in certain example embodiments of this invention coated articles have color characteristics as follows in Table 2. It is noted that subscript “G” stands for glass side reflective color, subscript “T” stands for transmissive color, and subscript “F” stands for film side color. As is known in the art, glass side (G) means reflective color when viewed from the glass side (as opposed to the layer/film side) of the coated article. Film side (F) (not shown in Table 2) means reflective color when viewed from the side of the coated article on which the coating 5 is provided.

TABLE 2
Color/Optical Characteristics due to/after Heat Treatment

| | General | Preferred | Most Preferred |
|---|---|---|---|
| ΔE*_{G} | <= 5.0 | <= 4.0 | <= 3.0 |
| ΔE*_{T} | <= 5.0 | <= 4.0 | <= 3.0 |
| a*_{G} | −6 to +6 | −4 to +4 | −3 to +3 |
| b*_{G} | −30 to +25 | −25 to +20 | −20 to +10 |
| Δa*_{G} | <= 1.0 | <= 0.7 | <= 0.5 |
| Δb*_{G} | <= 1.5 | <= 0.8 | <= 0.5 |
| ΔL*_{G} | <= 5 | <= 3 | <= 2 |
| Tᵥᵢₛ (TY): | 8-80% | 10-50% | 10-30% |
| Rₛ (Ω/sq): | <250 | <150 | <110 |

Coated articles after HT herein may even have a ΔE* value(s) (glass side reflective and/or transmissive) of no greater than 2.5, more preferably no greater than 2.0, and sometimes even no greater than 1.8 in certain example embodiments of this invention. In certain example embodiments, coated articles after HT herein may even have a ΔE* value(s) (glass side reflective and/or transmissive) of no greater than 1.5, or even 1.2.

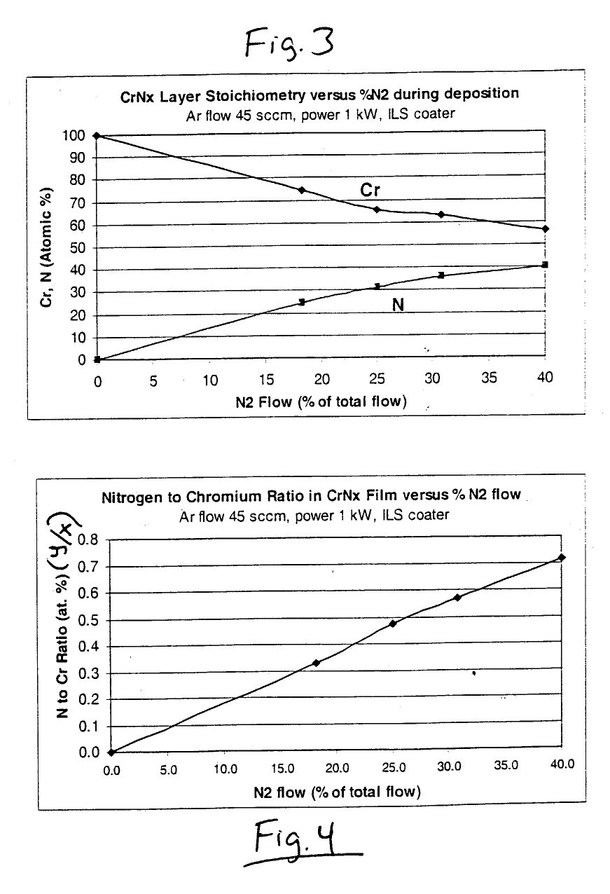

FIGS. 3-5 illustrate various stoichiometries of chromium nitride layer 3 according to different embodiments of this invention. In particular, these figures illustrate various ratios of N to Cr (ratios y/x) in the chromium nitride layer 3 as a function of nitrogen gas flow during the sputtering process in which the layer 3 is sputter-deposited. In these figures, the N and Cr atomic percentages (at. %) were determined using XPS. Additionally, it is noted that the correlation between nitrogen gas flows and the N to Cr ratio(s) was determined in accordance with the ILS coater used to deposit these samples since the flows were measured in this sputter coater.

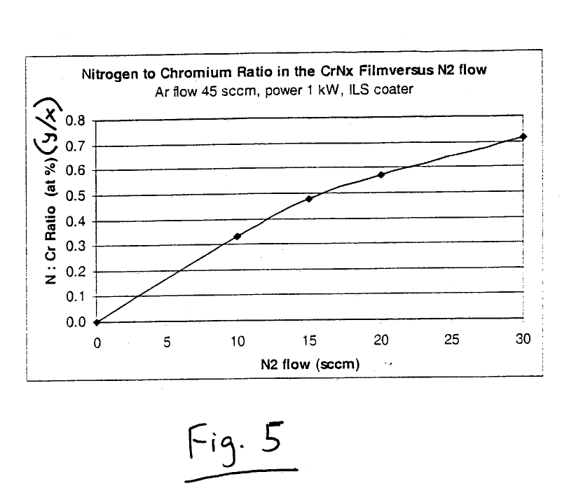

FIG. 3 is a graph plotting, during sputtering of a chromium nitride layer, nitrogen gas flow as a percentage of total gas flow (e.g., where Ar and N gases were used) vs. Cr, N atomic content in the resulting layer 3, illustrating stoichiometry of chromium nitride layers according to different embodiments of this invention as a function of nitrogen gas flow. FIG. 4 is a graph plotting nitrogen gas flow as a percentage of total gas flow during sputtering of a chromium nitride layer vs. the resulting ratio y/x (given CrₓN_{y}) in the resulting chromium nitride layer according to different embodiments of this invention, thereby illustrating different stoichiometries of the layer as a function of the amount of nitrogen in the total sputtering gas flow. FIG. 5 is a graph plotting nitrogen gas flow (in units of sccm) during sputtering of a chromium nitride layer vs. the resulting ratio y/x (given CrₓN_{y}) in the resulting chromium nitride layer according to different embodiments of this invention, thereby illustrating different stoichiometries of the layer as a function of nitrogen gas flow during sputtering.

As explained above, the best performance (balancing durability and solar performance) surprisingly occurs when the CrₓN_{y} layer 3 is characterized by a N to Cr ratio y/x of from 0.25 to 0.7 (even 0.25 to 0.9 in some instances), even more preferably from 0.3 to 0.6, still more preferably from 0.45 to 0.55.

For purposes of example only, a plurality of examples representing different example embodiments of this invention are set forth below.

### EXAMPLES 1-2

Examples 1-2 were monolithic coated articles (each ultimately annealed and heat treated). The Si₃N₄ layers 2 and 4 in each example were deposited by sputtering a silicon target (doped with about 10% Al) in an atmosphere including nitrogen gas. The chromium nitride layer 3 in each example was deposited by sputtering in an atmosphere including argon and nitrogen gas.

For Example 1, the following sputtering process parameters were used in depositing the coating. Line speed is in inches per minute (IPM), and gas (Ar and N) flows were in units of sccm:

TABLE 3
Example 1 Coating Process Parameters

| | | | Line | # | | |
|---|---|---|---|---|---|---|
| Layer | Power | Voltage | Speed | Passes | Ar flow | N flow |
| SiN layer 2: | 1.0 kW | 463 V | 41.2 | 2 | 40 | 40 |
| CrₓN_{y} layer 3: | 1.0 kW | 392 V | 41.5 | 2 | 45 | 15 |
| SiN layer 4: | 1.0 kW | 462 V | 41.2 | 7 | 40 | 40 |

For Example 2, the following sputtering process parameters were used in depositing the coating. Again, line speed is in inches per minute (IPM), and gas flows were in units of sccm:

TABLE 4
Example 2 Coating Process Parameters

| | | | Line | # | | |
|---|---|---|---|---|---|---|
| Layer | Power | Voltage | Speed | Passes | Ar flow | N flow |
| SiN layer 2: | 2.5 kW | 501 V | 44.5 | 8 | 40 | 55 |
| CrₓN_{y} layer 3: | 1.0 kW | 393 V | 38.1 | 2 | 45 | 15 |
| SiN layer 4: | 2.5 kW | 502 V | 41.3 | 2 | 40 | 55 |

After being sputtered, Examples 1-2 had the following characteristics after being sputtered (annealed and non-HT) (Ill. C, 2 degree observer):

TABLE 5
Characteristics (non- HT)

| Parameter | Ex. 1 | Ex. 2 |
|---|---|---|
| Tᵥᵢₛ (TY)(transmissive): | 22.5% | 20.9% |
| a*_{T} | −0.9 | −1.1 |
| b*_{T} | −4.6 | 2.4 |
| L*_{T} | 54.5 | 52.8 |
| R_{G}Y (glass side refl. %): | 31.5% | 18.5% |
| a*_{G}: | −2.2 | −1.1 |
| b*_{G}: | −4.2 | −19.0 |
| L*_{G}: | 62.9 | 50.1 |
| R_{F}Y (film side refl. %): | 20.7% | 34.7% |
| a*_{F}: | 0.3 | 0.1 |
| b*_{F}: | 24.4 | 17.6 |
| L*_{F}: | 52.6 | 65.5 |
| Tₛₒₗ (TS): | 18% | 18% |
| Shading Coefficient (SC): | 0.39 | 0.41 |
| SHGC: | 0.33 | 0.35 |
| Tᵤᵥ (UV transmission): | 20.3% | 16.0% |
| Rₛ (sheet resistance; ohms/sq.): | 86.4 | n/a |

Each of Examples 1 and 2 had a layer stack as follows, set forth in Table 6. The thicknesses and stoichiometries listed below in Table 6 for the Examples 1-2 are approximations and are not exact. The coating 5 for each Example is shown in FIG. 1, and thus includes layers 2, 3 and 4. The glass substrates were clear and about 6 mm thick in each Example.

TABLE 6
Coatings in Examples

| | |
|---|---|
| Example 1: | Glass/Si₃N₄(100 Å)/CrₓN_{y}(170 Å)/Si₃N₄(350 Å) |
| Example 2: | Glass/Si₃N₄(890 Å)/CrₓN_{y}(185 Å)/Si₃N₄(240 Å) |

After being sputter coated, each of Examples 1 and 2 was then heat treated for 10 minutes at about 625 degrees C. Table 7 below sets forth certain color stability characteristics of Examples 1-2 upon/after heat treatment (HT).

TABLE 7
Glass Side Refl. Color Stability Upon HT

| Parameter | Ex. 1 | Ex. 2 |
|---|---|---|
| ΔE*_{G}: | 0.8 | 1.7 |

As can be seen from Table 7, Examples 1-2 were characterized by excellent glass side reflective ΔE* values. The low numbers associated with these values illustrate how little the optical characteristics of the coating changed upon the heat treatment. This is indicative of superior stability upon heat treatment (e.g., thermal tempering or the like).

For purposes of comparison, consider the following layer stack: glass/Si₃N₄/NiCr/Si₃N₄, which has a glass side reflective ΔE* value of above 5.0 after heat treatment (HT) at 625 degrees C. for ten minutes. The Examples 1-2 above clearly illustrate the comparative advantage of using chromium nitride, as opposed to NiCr, for the IR reflecting layer. A much lower glass side reflective ΔE* value is achievable using chromium nitride. Moreover, durability may also be improved as explained above.

### EXAMPLES 3-5

As mentioned above, it has surprisingly been found that given CrₓN_{y} in layer 3, a ratio y/x (i.e., the ratio of N to Cr) of from 0.25 to 0.9, even more preferably from 0.3 to 0.7, still more preferably from 0.3 to 0.6, is superior to other ratios with respect to durability and optical characteristics. Examples 3-5 set forth below illustrate how different CrₓN_{y} layers 3 were made in a sputter coater (by sputtering) according to different embodiments of this invention, in various manner which kept the ratio y/x within the range of from 0.25 to 0.9. Examples 3-5 were each sputtered onto 3 mm clear glass substrates, with no silicon nitride layers thereon. The atomic percentages were measured in the resulting chromium nitride layers from the examples via XPS, as was the ratio y/x (given CrₓN_{y}).

TABLE 8
Sputtering of Examples 3-5

| Characteristic | Example 3 | Example 4 | Example 5 |
|---|---|---|---|
| Material: | CₓN_{y} | CₓN_{y} | CₓN_{y} |
| Power (kW): | 1 | 1 | 1 |
| U (V): | 397 | 399 | 402 |
| Pressure (mTorr): | 1.8 | 2.0 | 2.4 |
| Ar flow (sccm): | 45 | 45 | 45 |
| N flow (sccm): | 10 | 20 | 30 |
| % N flow (N/N + Ar): | 18.2 | 30.8 | 40.0 |
| Cr atomic %: | 74.4 | 62.8 | 56.2 |
| N atomic %: | 24.5 | 35.8 | 40.2 |
| Ratio y/x: | 0.33 | 0.57 | 0.72 |

It can be seen from Table 8 above numerous ways in which to sputter deposit chromium nitride in a manner such that the y/x ratio of N to Cr is in the desired range. In certain embodiments of this invention, the Cr atomic % in layer 3 is from 55 to 90%, more preferably from 60 to 85%, and even more preferably from 65 to 75%; whereas the N atomic % in layer 3 is from 15 to 50%, more preferably from 20 to 40%, and most preferably from 24 to 36%. These atomic % amounts of Cr and N surprisingly result in improve color stability with HT (i.e., low ΔE*) in combination with improved durability.

Accordingly, advantages associated with the use of chromium nitride as a IR reflecting layer include (a) improved corrosion resistance with respect to acid such as HCl; (b) improved mechanical performance such as better scratch resistance; and/or (c) improved thermal stability (i.e., lower ΔE* value(s)). In certain embodiments of this invention, coated articles may or may not be heat treated.

Certain terms are prevalently used in the glass coating art, particularly when defining the properties and solar management characteristics of coated glass. Such terms are used herein in accordance with their well known meaning. For example, as used herein:

Intensity of reflected visible wavelength light, i.e. “reflectance” is defined by its percentage and is reported as RₓY (i.e. the Y value cited below in ASTM E-308-85), wherein “X” is either “G” for glass side or “F” for film side. “Glass side” (e.g. “G”) means, as viewed from the side of the glass substrate opposite that on which the coating resides, while “film side” (i.e. “F”) means, as viewed from the side of the glass substrate on which the coating resides.

Color characteristics are measured and reported herein using the CIE LAB a*, b* coordinates and scale (i.e. the CIE a*b* diagram, Ill. CIE-C, 2 degree observer). Other similar coordinates may be equivalently used such as by the subscript “h” to signify the conventional use of the Hunter Lab Scale, or Ill. CIE-C, 10⁰ observer, or the CIE LUV u*v* coordinates. These scales are defined herein according to ASTM D-2244-93 “Standard Test Method for Calculation of Color Differences From Instrumentally Measured Color Coordinates” Sep. 15, 1993 as augmented by ASTM E-308-85, Annual Book of ASTM Standards, Vol. 06.01 “Standard Method for Computing the Colors of Objects by 10 Using the CIE System” and/or as reported in IES LIGHTING HANDBOOK 1981 Reference Volume.

The terms “emittance” and “transmittance” are well understood in the art and are used herein according to their well known meaning. Thus, for example, the terms visible light transmittance (TY), infrared radiation transmittance, and ultraviolet radiation transmittance (Tᵤᵥ) are known in the art. Total solar energy transmittance (TS) is then usually characterized as a weighted average of these values from 300 to 2500 nm (UV, visible and near IR). With respect to these transmittances, visible transmittance (TY), as reported herein, is characterized by the standard CIE Illuminant C, 2 degree observer, technique at 380-720 nm; near-infrared is 720-2500 nm; ultraviolet is 300-380 nm; and total solar is 300-2500 nm. For purposes of emittance, however, a particular infrared range (i.e. 2,500-40,000 nm) is employed.

Visible transmittance can be measured using known, conventional techniques. For example, by using a spectrophotometer, such as a Perkin Elmer Lambda 900 or Hitachi U4001, a spectral curve of transmission is obtained. Visible transmission is then calculated using the aforesaid ASTM 308/2244-93 methodology. A lesser number of wavelength points may be employed than prescribed, if desired. Another technique for measuring visible transmittance is to employ a spectrometer such as a commercially available Spectrogard spectrophotometer manufactured by Pacific Scientific Corporation. This device measures and reports visible transmittance directly. As reported and measured herein, visible transmittance (i.e. the Y value in the CIE tristimulus system, ASTM E-308-85) uses the Ill. C.,2 degree observer.

Another term employed herein is “sheet resistance”. Sheet resistance (Rₛ) is a well known term in the art and is used herein in accordance with its well known meaning. It is here reported in ohms per square units. Generally speaking, this term refers to the resistance in ohms for any square of a layer system on a glass substrate to an electric current passed through the layer system. Sheet resistance is an indication of how well the layer or layer system is reflecting infrared energy, and is thus often used along with emittance as a measure of this characteristic. “Sheet resistance” may for example be conveniently measured by using a 4-point probe ohmmeter, such as a dispensable 4-point resistivity probe with a Magnetron Instruments Corp. head, Model M-800 produced by Signatone Corp. of Santa Clara, Calif.

“Chemical durability” or “chemically durable” is used herein synonymously with the term of art “chemically resistant” or “chemical stability”. For example, chemical durability may be determined by boiling a sample of a coated glass substrate in about 500 cc of 5% HCl for one hour (i.e. at about 195° F.). Alternatively, chemical durability may be determined by an NaOH boil which includes boiling a sample of a coated glass substrate in a solution having a pH of about 12.2 that is a mixture of water and NaOH (about 0.4% NaOH); the solution is available from LabChem, Inc., Cat. No. LC 24270-4 (this is what is meant by NaOH boil herein). The NaOH boil may be carried out at a temperature of about 145 degrees F. (Examples above), or about 195 degrees F. in other instances.

The terms “heat treatment” and “heat treating” as used herein mean heating the article to a temperature sufficient to enabling thermal tempering, bending, and/or heat strengthening of the glass inclusive article. This definition includes, for example, heating a coated article to a temperature of at least about 580 or 600 degrees C. for a sufficient period to enable tempering. In some instances, the HT may be for at least about 4 or 5 minutes.

Once given the above disclosure many other features, modifications and improvements will become apparent to the skilled artisan. Such other features, modifications and improvements are therefore considered to be a part of this invention, the scope of which is to be determined by the following claims:

What is claimed is:

1. A heat treated coated article comprising:
a layer system supported by a glass substrate, said layer system comprising a layer comprising chromium nitride located between first and second dielectric layers, wherein the second dielectric layer is at least partially nitrided and positioned so that the layer comprising chromium nitride is between the second dielectric layer and the glass substrate; and
wherein said coated article has a ΔE* value (glass side reflective and/or transmissive) no greater than 4.0 after heat treatment at a temperature(s) of at least about 600 degrees C.

2. The coated article of claim 1, wherein said coated article has a ΔE* value (glass side reflective and/or transmissive) no greater than 3.0 after said heat treatment.

3. The coated article of claim 1, wherein said coated article has a ΔE* value (glass side reflective and/or transmissive) no greater than 2.5 after said heat treatment.

4. The coated article of claim 1, wherein said coated article has a ΔE* value (glass side reflective and/or transmissive) no greater than 2.0 after said heat treatment.

5. The coated article of claim 1, wherein said coated article has a ΔE* value (glass side reflective) no greater than 3.0 after said heat treatment.

6. The coated article of claim 1, wherein said layer comprising chromium nitride directly contacts each of said dielectric layers, and wherein at least one of said dielectric layers comprises silicon nitride.

7. The coated article of claim 1, wherein said chromium nitride is characterized by CrₓN_{y}, where y/x is from 0.25 to 0.7.

8. The coated article of claim 1, wherein said chromium nitride is characterized by CrₓN_{y}, where y/x is from 0.3 to 0.6.

9. The coated article of claim 1, wherein said chromium nitride is characterized by CrₓN_{y}, where y/x is from 0.45 to 0.55.

10. The coated article of claim 1, wherein said layer comprising chromium nitride includes from about 55 to 90 atomic % chromium, and from about 15 to 50 atomic % nitrogen.

11. The coated article of claim 1, wherein said layer comprising chromium nitride is substantially free of Ni.

12. A heat treated coated article including a layer system supported by a glass substrate, the layer system comprising:
a first layer comprising silicon nitride;
a layer comprising chromium nitride provided on the glass substrate over the first layer comprising silicon nitride;
a second layer comprising silicon nitride provided on the glass substrate over the layer comprising chromium nitride;
wherein the layer comprising chromium nitride is sandwiched between and contacts each of the first and second layers comprising silicon nitride; and
wherein the coated article has a ΔE* value (glass side reflective) of no greater than 3.0 after and/or due to heat treatment.

13. The coated article of claim 12, wherein the coated article has a ΔE* value (glass side reflective) of no greater than 2.0 after and/or due to heat treatment.

14. The coated article of claim 12, wherein the layer comprising chromium nitride is represented by CrₓN_{y}, where a ratio y/x of N to Cr is from 0.25 to 0.7.

15. The coated article of claim 12, wherein the layer system consists essentially of the first and second layers comprising silicon nitride and the layer comprising chromium nitride.

16. The coated article of claim 12, wherein the coated article has no metallic infrared (IR) reflecting layer.

17. The coated article of claim 12, wherein the layer comprising chromium nitride does not contact any metal layer.

18. The coated article of claim 12, wherein the layer comprising chromium nitride is formed so that it is nitrided as deposited.

19. The coated article of claim 12, wherein the coated article is an IG window unit, a monolithic window, or a laminated window.

20. A coated article including a layer system supported by a glass substrate, the layer system comprising:
a first dielectric layer;
a layer comprising chromium nitride CrₓN_{y} provided on the glass substrate over the first dielectric layer, where a ratio y/x of N to Cr in the layer comprising chromium nitride is from 0.25 to 0.7; and
a second dielectric layer provided on the glass substrate over the layer comprising chromium nitride.

21. The coated article of claim 20, wherein the coated article has a visible transmission of from 8 to 80%.

22. The coated article of claim 20, wherein the coated article is thermally tempered and has a ΔE* value (glass side reflective) of no greater than 3.0 after and/or due to heat treatment used in tempering.

23. The coated article of claim 20, wherein the coated article is heat treatable, and if subjected to heat treatment at 625 degrees C. would have a ΔE* value (glass side reflective) of no greater than 3.0 after and/or due to heat treatment.

24. The coated article of claim 20, wherein the coated article is heat treatable, and if subjected to heat treatment at temperature(s) of at least about 600 degrees C. would have a ΔE* value (glass side reflective) of no greater than 3.0 after and/or due to heat treatment.

25. A heat treatable coated article including a coating supported by a glass substrate, the coating comprising:
a first dielectric layer;
a layer comprising chromium nitride;
a second dielectric layer; and
wherein layers of the coated article are of respective thicknesses and materials so that if subjected to heat treatment at temperature(s) of at least about 600 degrees C. the coated article would have a ΔE* value of no greater than 3.0.

26. The coated article of claim 25, wherein the coated article does not include any IR reflecting layer of silver or gold.

27. A method of making a coated article, the method comprising:
sputtering a first dielectric layer on a substrate;
sputtering a layer comprising chromium nitride on the substrate over the first dielectric layer;
sputtering a second dielectric layer on the substrate over the layer comprising chromium nitride; and
wherein the layer comprising chromium nitride is sputtered so as to form CrₓN_{y} where y/x is from 0.25 to 0.7.

28. The method of claim 27, further comprising heat treating the coated article at a temperature(s) of at least 580-600 degrees C., so that the coated article has a ΔE* value (glass side reflective and/or transmissive) of no greater than 3.0 due to the heat treating.
